(19) United States
(12) Patent Application Publication
(10) Pub. No.: US 2023/0262000 A1
(43) Pub. Date: Aug. 17, 2023

(54) SYSTEM AND METHOD FOR MAINTAINING COMMUNICATION SERVICE QUALITY IN A NETWORK

(71) Applicant: Saudi Arabian Oil Company, Dhahran (SA)

(72) Inventors: Kashif Khawaja, Dhahran (SA); Khaled W. Zahid, Al-Khobar (SA); Mohammed M. Kaheli, Dhahran (SA); AbdulMajeed J. Fayez, Dammam (SA); Ahmad J. Al Majed, Al Khuzama (SA)

(21) Appl. No.: 17/651,480

(22) Filed: Feb. 17, 2022

(51) Int. Cl. H04L 47/22; H04L 47/2416; H04L 47/125; H04L 47/10; H04L 41/14; H04L 43/062

(52) U.S. Cl. CPC H04L 47/22; H04L 41/145; H04L 43/062; H04L 47/18; H04L 47/125; H04L 47/2416

(57) ABSTRACT

A system and method maintain communication service quality in a network. The method comprises providing a network of nodes including a network component and at least two user endpoints, implementing a physical connection between at least two nodes in the network, implementing virtual connections between all of the nodes using a metering module disposed in at least one node which meters actual traffic on the physical connections at the nodes, generating synthetic traffic on the virtual connections to simulate traffic by the at least two user endpoints, metering the synthetic traffic on the virtual connections at the nodes using the metering module, generating traffic data metrics from the actual traffic and the synthetic traffic in the network, diagnosing network connectivity from the traffic data metrics using a diagnostic module, and rectifying quality-related issues of the network from the diagnosed network connectivity using a remediation module. The system implements the method.

### FIELD OF THE DISCLOSURE

The present disclosure relates generally to communication service quality, and, more particularly, to a system and method for maintaining communication service quality in a network.

### BACKGROUND OF THE DISCLOSURE

In an implementation of voice over IP (VoIP) based on an IP Multimedia Subsystem (IMS), the most critical flows occur between user endpoint (UE) devices and the IMS core sites for call signaling, as well as between the various UEs for processing media such as voice, video, etc. If there is a disruption or extended delay of any kind between the UE and an IMS core site, a call may not even be established, much less be delayed. This could include emergency calls, which can result in delays in servicing emergencies. If a disruption or extended delay happens to traffic on the path between two UEs, the quality of voice communications can be significantly degraded, to the extent that either both or all parties may not be able to discern speech, video, or other multimedia, essentially making the call useless. This would again be an undesirable situation if the call is of emergency nature.

Since VoIP is considered real-time traffic, any disruption, while generally unnoticeable by some Internet applications, is immediately perceived by human users. More often than not, the network is viewed as the cause of the disruption. There is typically not enough data to diagnose the network connectivity end-to-end with near real-time VoIP traffic.

### SUMMARY OF THE DISCLOSURE

According to an embodiment consistent with the present disclosure, a system and method maintain communication service quality in a network.

In an embodiment, a method comprises providing a network of nodes including a network component and at least two user endpoints, implementing a physical connection between at least two nodes in the network, implementing virtual connections between all of the nodes using a metering module disposed in at least one node which meters actual traffic on the physical connections at the nodes, generating synthetic traffic on the virtual connections to simulate traffic by the at least two user endpoints, metering the synthetic traffic on the virtual connections at the nodes using the metering module, generating traffic data metrics from the actual traffic and the synthetic traffic in the network, diagnosing network connectivity from the traffic data metrics using a diagnostic module, and rectifying quality-related issues of the network from the diagnosed network connectivity using a remediation module.

The metering of the synthetic traffic is performed using at least the metering module at the network component. In addition, the metering of the actual traffic is performed using at least the metering module at the network component. Alternatively, the metering of the actual traffic and the synthetic traffic is performed using at least the metering module at the network component. The at least two user endpoints are Voice-Over-IP (VOIP) user endpoints. The metering modules implement the Internet Protocol Service Level Agreement (IP SLA) communication protocol. Alternatively, the metering modules implement an active measurement protocol (AMP).

In another embodiment, a system comprises a plurality of user endpoint devices and a network component. Each user endpoint device includes a device metering module having a processor including code therein configured to measure actual traffic in a network. The network component is operatively connected to each user endpoint device by physical connections. The network component includes a network metering module, a diagnostic module, and a remediation module. The network metering module has a processor including code therein configured to implement virtual connections between the network component and all of the plurality of user endpoints (does this mean “user” subnets on the remote network component end?), to generate synthetic traffic on the virtual connections to simulate traffic by at least two user endpoints, to measure the in the network on the physical connections, to measure the synthetic traffic in the network on the virtual connections, and to generate traffic data metrics from the synthetic traffic in the network. The diagnostic module has a processor including code therein configured to diagnose network connectivity of the network from the traffic data metrics. The remediation module has a processor including code therein configured to rectify a quality-related issue of the network from the diagnosed network connectivity.

Each device metering module and the network metering module implement virtual connections between all of the plurality of user endpoint devices. Alternatively, each device metering module and the network metering module implement virtual connections between the network component and each of the plurality of user endpoint devices. The at least two user endpoints can be Voice-Over-IP (VOIP) user endpoints. The plurality of user endpoint devices and the network component can be nodes in the network. Each device metering module and the network metering module can implement the Internet Protocol Service Level Agreement (IP SLA) communication protocol. Alternatively, each device metering module and the network metering module can implement an active measurement protocol (AMP).

In a further embodiment, a network comprises a plurality of nodes having physical connections therebetween, wherein the nodes include a plurality of user endpoint devices and a network component. Each user endpoint device includes a device metering module having a processor including code therein configured to measure actual traffic on the physical connections in the network. The network component is operatively connected to each user endpoint device by the connections. The network component includes a network metering module, a diagnostic module, and a remediation module. The network metering module has a processor including code therein configured to implement virtual connections between the network component and all of the plurality of user endpoints, to generate synthetic traffic on the virtual connections to simulate traffic by at least two user endpoints, to measure the actual traffic on the physical connections in the network, to measure the synthetic traffic in the network on the virtual connections, and to generate traffic data metrics from the actual traffic and the synthetic traffic in the network. The diagnostic module having a processor including code therein configured to diagnose network connectivity of the network from the traffic data metrics. The remediation module has a processor including code therein configured to rectify a quality-related issue of the network from the diagnosed network connectivity.

Each device metering module and the network metering module can implement virtual connections between all of the plurality of user endpoint devices. Alternatively, each device metering module and the network metering module can implement virtual connections between the network component and each of the plurality of user endpoint devices. At least two user endpoints can be Voice-Over-IP (VOIP) user endpoints. Each device metering module and the network metering module can implement the Internet Protocol Service Level Agreement (IP SLA) communication protocol. Alternatively, each device metering module and the network metering module can implement an active measurement protocol (AMP).

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic of a network having a network component and user endpoint devices, according to an embodiment.

FIG. 2 is a schematic of a module according to the embodiment of FIG. 1.

FIG. 3 is a flowchart of a method for maintaining communication service quality in a network.

It is noted that the drawings are illustrative and are not necessarily to scale.

### DETAILED DESCRIPTION OF CERTAIN EMBODIMENTS OF THE DISCLOSURE

Example embodiments consistent with the teachings included in the present disclosure are directed to a system and method for maintaining communication service quality in a network.

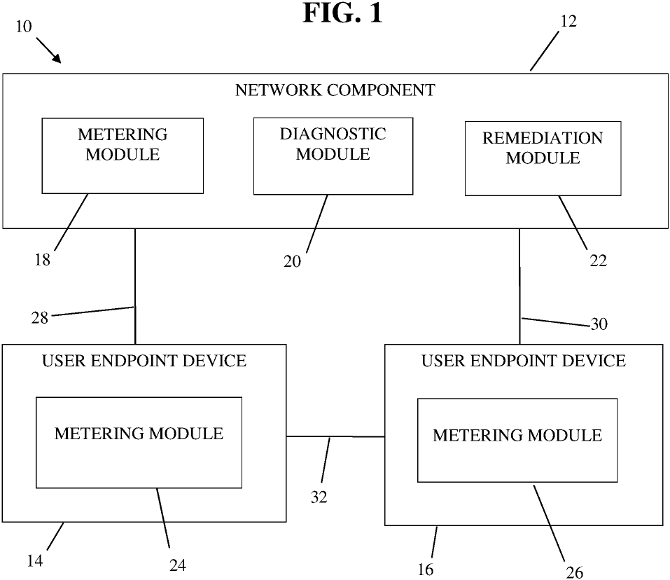

Referring to FIG. 1, a system 10 includes a network component 12 and a plurality of user endpoint devices 14, 16. The network component 12 and user endpoint devices 14, 16 can be nodes in a network. Each user endpoint device 14, 16 can be an Internet Protocol (IP) based phone. In addition, each user endpoint device 14, 16 can be a VoIP software client. Also, each user endpoint device 14, 16 can be an analog gateway. Furthermore, each user endpoint device 14, 16 can be switch which converts analog signals to IP and vice versa. Alternatively, each user endpoint device 14, 16 can be a voice application that uses the Transmission Control Protocol (TCP). In addition, each user endpoint device 14, 16 can be a voice application that uses the User Datagram Protocol (UDP). Moreover, each user endpoint device 14, 16 can be a video application that uses the Transmission Control Protocol (TCP). Still further, each user endpoint device 14, 16 can be a video application that uses the User Datagram Protocol (UDP). The network can be the Internet. Alternatively, the network can be a local area network (LAN). In addition, the network can be a wide area network (WAN). The network component 12 includes a metering module 18, a diagnostic module 20, and a remediation module 22.

Each user endpoint device 14, 16 also includes a metering module 24, 26, respectively. The metering modules 18, 24, 26 can determine metrics of the traffic to and from the network component 12 and the user endpoint devices 14, 16, respectively. Using the metrics, the network component 12 can determine the quality of service (QoS) of the system 10. In addition, using the metrics, the network component 12 can determine other known operating characteristics of the system 10, such as latency. The diagnostic module 20 can diagnose the network connectivity. For example, the network connectivity of end-to-end devices with near real-time VoIP traffic occurring in the system 10 can be determined by the diagnostic module 20. The network connectivity can be determined to be underperforming using the metrics. In response to the quality-related issues which can affect the network connectivity, the remediation module 22 can take pre-emptive measures to remediate and rectify the quality-related issues based on the underperforming metrics.

The user endpoint devices 14, 16 are operatively connected to the network component 12 through network communication channels 28, 30, respectively. In addition, at least two of the plurality of user endpoint devices, for example, the user endpoint devices 14, 16, are operatively connected to each other through a network communication channel 32. The network communication channels 28, 30, 32 can be actual physical connections between the respective devices 12, 14, 16. Alternatively, as described below, the network communication channels 28, 30, 32 can be synthetic connections between the respective devices 12, 14, 16.

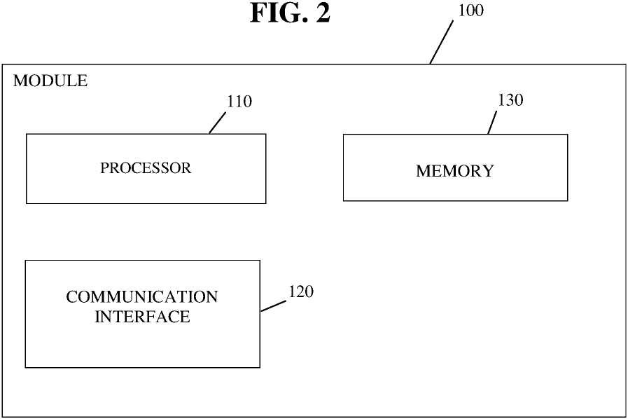

Referring to FIG. 2, each module described herein can be implemented as a module 100. Each module 100 includes a processor 110, a communication interface 120, and a memory 130. The processor 110 includes code therein configured to operate the module 100. The communication interface 120 can be any known input/output device configured to receive and transmit data, respectively. In addition, the communication interface 120 can implement any known communication protocol configured to communicate over a respective communication channel 28, 30, 32. For example, the communication interface 120 can implement a two-way active measurement protocol (TWAMP). Alternatively, the communication interface 120 can implement a one-way active measurement protocol (OWAMP). The memory 120 can store data used by the processor 110. The memory 120 can also store data received or transmitted by the communication interface 120.

The communication interfaces 120 can implement a physical connection between at least two nodes in a network of devices 12, 14, 16. For example, the physical connections can be the channels 28, 30, 32 interconnecting the devices 12, 14, 16 as nodes of the network. In a specific embodiment, at least two of the user endpoint devices 14, 16 can be VoIP user endpoints to establish VoIP communications between the users of the at least two user endpoint devices 14, 16. The metering modules 18, 24, 26 can meter actual traffic on the physical connections at each node of the network.

The metering modules 18, 24, 26 of the system 10, using their respective communication interfaces 120, can implement the Internet Protocol Service Level Agreement (IP SLA) communication protocol, commercially available from CISCO SYSTEMS, INC. Alternatively, the metering modules 18, 24, 26, using their respective communication interfaces 120, can implement a two-way active measurement protocol (TWAMP). In addition, the metering modules 18, 24, 26, using their respective communication interfaces 120, can implement a one-way active measurement protocol (OWAMP).

Using IP SLA, at least one of the metering modules 18, 24, 26 can implement virtual connections between all of the nodes of a network. In addition, using IP SLA, at least one of the metering modules 18, 24, 26 can generate synthetic traffic on the virtual connections to simulate traffic by at least two user endpoint devices. Such synthetic traffic can be metered by at least one of the metering modules 18, 24, 26. Accordingly, traffic data metrics from the actual traffic and the synthetic traffic in the network are generated by the at least one metering module 18, 24, 26. Since the synthetic traffic supplements the actual traffic with the network, the traffic data metrics provide enough data to diagnose network connectivity using the diagnostic module 20. The diagnostic module takes the traffic metric data, and runs it through a trained Machine Learning module to intelligently determine the deviations from norm. Depending on which area shows abnormal behavior i.e. packet loss, inadequate delay, jitter (variation in delay), network processing delay, endpoint/server processing delay, MOS score, etc., the diagnostic module 20 invokes external network management systems to check the health of the identified network resources. If the diagnostic module 20 determines that the health check parameters are off, by comparison to stored data such as in the memory 130, then the remediation module will be invoked.

In this manner, underperforming metrics can be identified as a result of the network of synthetic connections. The diagnostic module 20 can also generate a network connectivity report and create monitoring products using the collected traffic metric data. The network connectivity report and monitoring products can be output through the communication interface 120 of the diagnostic module 20 to an administrator.

In addition, the diagnostic module 20 can transmit the underperforming metrics, through its communication interface 120, to the remediation module 22. In response to the identified underperforming metrics, remediation module 22 remediates and rectifies quality-related issues of the network. Accordingly, the system 10 can detect network connectivity and maintain communication service quality in a network. The remediation module 22 performs either of the two categories of actions: (1) alert a network management team to take action or (2) depending on the network resource with the issue, attempt to communicate with additional network management systems to re-route/bypass the affected resources. Additionally, the remediation module 22 can be configured to attempt to reload/restart the network resource (if so configured to do so by the network operator). Finally, if necessary, similar to (1) a network management team is engaged to take a deeper look into the network resource to determine the cause of poor performance.

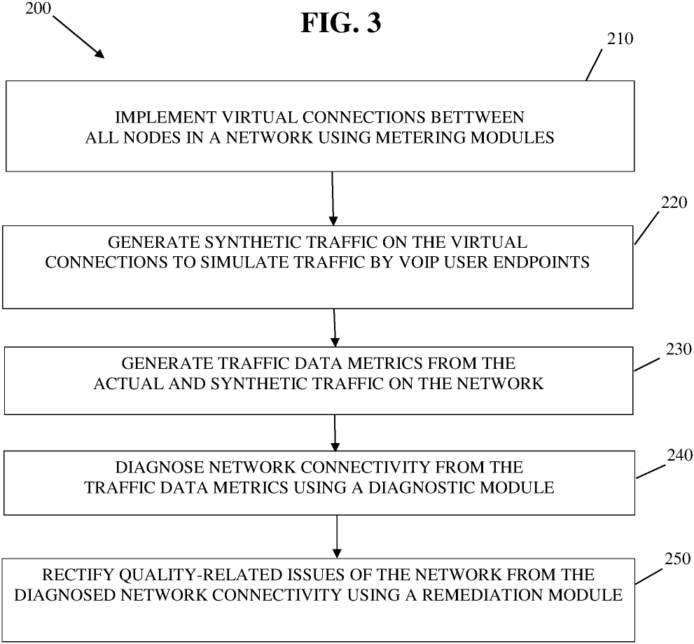

Referring to FIG. 3, a method 200 of operation of the system 10 to maintain the communication service quality in the network includes the step 210 of implementing virtual connections between all nodes in a network using at least one of the metering modules 18, 24, 26. The method 200 then generates synthetic traffic on the virtual connections in step 220 to simulate traffic by VoIP user endpoints, such as the user endpoint devices 14, 16. The method 200 then generates traffic data metrics using the metering modules 18, 24, 26 from the physical and synthetic traffic on the network in step 230. The method 200 diagnoses network connectivity from the traffic data metrics using the diagnostic module 20 in step 240. In response to the diagnosed network connectivity, the method 200 rectifies quality-related issues of the network using the remediation module 22 in step 250.

Portions of the methods described herein can be performed by software or firmware in machine readable form on a tangible (e.g., non-transitory) storage medium. For example, the software or firmware can be in the form of a computer program including computer program code adapted to cause the system to perform various actions described herein when the program is run on a computer or suitable hardware device, and where the computer program can be embodied on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A method, comprising:
providing a network of nodes, including a network component and at least two user endpoints;
implementing a physical connection between at least two nodes in the network;
implementing virtual connections between all of the nodes using a metering module disposed in at least one node which meters actual traffic on the physical connections at the nodes;
generating synthetic traffic on the virtual connections to simulate traffic by the at least two user endpoints;
metering the synthetic traffic on the virtual connections at the nodes using the metering module;
generating traffic data metrics from the actual traffic and the synthetic traffic in the network;
diagnosing network connectivity from the traffic data metrics using a diagnostic module; and
rectifying quality-related issues of the network from the diagnosed network connectivity using a remediation module.

2. The method of claim 1, wherein the metering of the synthetic traffic is performed using at least the metering module at the network component.

3. The method of claim 1, wherein the metering of the actual traffic is performed using at least the metering module at the network component.

4. The method of claim 1, wherein the metering of the actual traffic and the synthetic traffic is performed using at least the metering module at the network component.

5. The method of claim 1, wherein the at least two user endpoints are Voice-Over-IP (VOIP) user endpoints.

6. The method of claim 1, wherein the metering modules implement the Internet Protocol Service Level Agreement (IP SLA) communication protocol.

7. The method of claim 1, wherein the metering modules implement an active measurement protocol (AMP).

8. A system, comprising:
a plurality of user endpoint devices, wherein each user endpoint device includes:
a device metering module having a processor including code therein configured to measure actual traffic in a network; and
a network component operatively connected to each user endpoint device by physical connections, wherein the network component includes:
a network metering module having a processor including code therein configured to implement virtual connections between the network component and all of the plurality of user endpoints, to generate synthetic traffic on the virtual connections to simulate traffic by at least two user endpoints, to measure the actual traffic in the network on the physical connections, to measure the synthetic traffic in the network on the virtual connections, and to generate traffic data metrics from the actual traffic and the synthetic traffic in the network;
a diagnostic module having a processor including code therein configured to diagnose network connectivity of the network from the traffic data metrics; and
a remediation module having a processor including code therein configured to rectify a quality-related issue of the network from the diagnosed network connectivity.

9. The system of claim 8, wherein each device metering module and the network metering module implement virtual connections between all of the plurality of user endpoint devices.

10. The system of claim 8, wherein each device metering module and the network metering module implement virtual connections between the network component and each of the plurality of user endpoint devices.

11. The system of claim 8, wherein the at least two user endpoints are Voice-Over-IP (VOIP) user endpoints.

12. The system of claim 8, wherein the plurality of user endpoint devices and the network component are nodes in the network.

13. The system of claim 8, wherein each device metering module and the network metering module implement the Internet Protocol Service Level Agreement (IP SLA) communication protocol.

14. The system of claim 8, wherein each device metering module and the network metering module implement an active measurement protocol (AMP).

15. A network, comprising:
a plurality of nodes having physical connections therebetween, wherein the nodes include a plurality of user endpoint devices and a network component;
wherein each user endpoint device includes:
a device metering module having a processor including code therein configured to measure actual traffic on the physical connections in the network; and
wherein the network component operatively connected to each user endpoint device by the connections, wherein the network component includes:
a network metering module having a processor including code therein configured to implement virtual connections between the network component and all of the plurality of user endpoints, to generate synthetic traffic on the virtual connections to simulate traffic by at least two user endpoints, to measure the actual traffic on the physical connections in the network, to measure the synthetic traffic in the network on the virtual connections, and to generate traffic data metrics from the actual traffic and the synthetic traffic in the network;
a diagnostic module having a processor including code therein configured to diagnose network connectivity of the network from the traffic data metrics; and
a remediation module having a processor including code therein configured to rectify a quality-related issue of the network from the diagnosed network connectivity.

16. The system of claim 15, wherein each device metering module and the network metering module implement virtual connections between all of the plurality of user endpoint devices.

17. The system of claim 15, wherein each device metering module and the network metering module implement virtual connections between the network component and each of the plurality of user endpoint devices.

18. The network of claim 15, wherein at least two user endpoints are Voice-Over-IP (VOIP) user endpoints.

19. The network of claim 15, wherein each device metering module and the network metering module implement the Internet Protocol Service Level Agreement (IP SLA) communication protocol.

20. The network of claim 15, wherein each device metering module and the network metering module implement an active measurement protocol (AMP).
